(19) United States
(12) Patent Application Publication
(10) Pub. No.: US 2012/0006692 A1
(43) Pub. Date: Jan. 12, 2012

(54) SOLID ELECTROLYTE GAS SENSOR FOR MEASURING VARIOUS GAS SPECIES

(75) Inventors: Dirk Liemersdorf, Sachsenheim (DE); Berndt Cramer, Leonberg (DE)

(73) Assignee: ROBERT BOSCH GMBH, Stuttgart (DE)

(21) Appl. No.: 13/203,805

(22) PCT Filed: Feb. 11, 2010
(86) PCT No.: PCT/EP2010/051713

§ 371 Date: Aug. 29, 2011

(30) Foreign Application Priority Data
Feb. 27, 2009 (DE) 10 2009 001 249.4

(51) Int. Cl. G01N 27/409; G01N 27/407

(52) U.S. Cl. 205/784; 204/424

(57) ABSTRACT

In a sensor element for a solid electrolyte gas sensor, comprising a gas-tight pumping chamber, a heater, a first pumping electrode arranged in the pumping chamber, and an at least second pumping electrode, an autonomous pumping cell is arranged as a gas inflow restrictor instead of a diffusion barrier. The autonomous pumping cell comprises an outer and an inner autonomous pumping electrode which are contacted or short-circuited from outside by means of a trimmable resistor.

### BACKGROUND OF THE INVENTION

The invention relates to a sensor element for a solid electrolyte gas sensor, to a corresponding solid electrolyte gas sensor and to a method for operating such a sensor.

In the field of motor vehicle technology, wideband lambda probes formed as solid electrolyte oxygen sensors are known, by means of which the oxygen partial pressure or the residual oxygen partial pressure of an exhaust gas can be measured. They consist of a solid electrolyte in which a cavity used as a pumping chamber is arranged, the latter being connected to the exhaust gas or a corresponding combustion engine by means of a diffusion barrier. These probes furthermore contain an air reference channel connected to the ambient air.

In the case of oxygen-rich exhaust gas, oxygen is electrochemically removed from said pumping chamber, the relevant oxygen diffusion current being used as a measurement variable for the oxygen partial pressure in the exhaust gas. In the case of an exhaust gas with an oxygen deficit, the pumping direction is reversed.

Besides said wideband probes, there are also proportional probes which can be operated either in exhaust gas with an oxygen excess or in exhaust gas with an oxygen deficit, but not for the entire wideband range. As in the case of the wideband probe, oxygen is also removed from a diffusion-restricted pumping chamber in these probes. The oxygen diffusion current then continues as an electrically measurable pumping current and is used as a measurement variable for the oxygen partial pressure in the exhaust gas. Since there is no information about the rich or lean state of the exhaust gas owing to the lack of a control variable from the unloaded Nernst cell, there is in this case no possibility of pumping oxygen electrochemically into or out of the pumping chamber as a function of the exhaust gas composition, so as to produce a wideband probe.

So-called mixed potential sensors are furthermore known, which are constructed in a similar way to a lambda step-change probe and consist of an electrochemical cell, in which there is a first platinum electrode in the exhaust gas. A second platinum electrode is separated from the exhaust gas space by the solid electrolyte and is in communication with the ambient air by means of a said air reference channel.

### SUMMARY OF THE INVENTION

The present invention is based on the concept, in a solid electrolyte gas sensor of the type in question here, of arranging an autonomous pumping cell as a gas inflow restriction in the respective sensor element instead of said diffusion barrier.

In a preferred embodiment, the autonomous pumping cell comprises two loaded or short-circuited pumping electrodes, specifically an outer and an inner autonomous pumping electrode, which do not need to be contacted from the outside. By the short circuit or the ohmic load (i.e. using an ohmic load resistor) of the outer and inner autonomous pumping electrodes, a migration current is formed which is driven by the Nernst voltage or mixed potential voltage that is formed. The pumping properties can be established by means of the ohmic load respectively set.

In an alternative configuration, the autonomous pumping cell is formed by an outer and an inner autonomous pumping electrode, which are contacted or connected from the outside by/to a controller, for example a control circuit, evaluation circuit or the like, so that the at least two pumping electrodes can be modified in-situ from the outside. By means of this controller, a diffusion behavior is preferably simulated similarly as in the case of a diffusion barrier, and preferably by varying the electrical resistance of the two pumping electrodes. By means of such a pumping cell, it is consequently possible to produce the function of a diffusion barrier, although in contrast to the prior art the diffusion barrier can still be adjusted or trimmed during operation of the pumping cell (i.e. in situ).

The essential advantage of the solid electrolyte gas sensor according to the invention is the reduction in the number of contacts. With the proposed sensor, the outlay is also reduced compared with the calibration step required in the prior art, and ageing processes of such diffusion barriers are fully avoided or can be compensated for in situ, so that the sensor according to the invention is easier to operate compared with the prior art and actually longer-lasting.

By means of the gas sensor according to the invention, the oxygen partial pressure or residual oxygen partial pressure can be determined quantitatively throughout the entire lambda range. By modifying the readily accessible outer autonomous pumping electrode, for example in the form of a mixed potential electrode, adaptation of the sensor for the detection of further (different) gas species can also be carried out.

The present invention furthermore relates to a method for operating a sensor element according to the invention, or a corresponding solid electrolyte gas sensor, for the quantitative detection of oxygen, wherein a constant voltage is applied between two measurement electrodes and wherein the electrical pumping current resulting from the applied constant voltage is used as a measurement variable for the oxygen partial pressure in the exhaust gas.

In the method according to the invention, different states of the autonomous pumping cell can be set by means of the applied constant voltage.

In the method according to the invention, a reduced pressure can furthermore be set in the closed pumping chamber, so that a positive pumping current is still generated even in relatively rich exhaust gas, i.e. an exhaust gas with a relatively low air factor lambda.

It should be noted that the solid electrolyte gas sensor according to the invention can be used with said advantages not only in the field of motor vehicle technology, but also in any combustion engine machines or burners in which, for example, lambda probes of the type in question here are employed.

### BRIEF DESCRIPTION OF THE DRAWINGS

The invention will be explained in more detail below with reference to the appended drawings with the aid of preferred exemplary embodiments, by which further features and advantages of the invention are revealed. In the drawings, corresponding or functionally equivalent features are provided with the same reference numbers.

In detail:

FIG. 1 shows a longitudinal section through a sensor element of a wideband lambda probe according to the prior art;

FIG. 2 shows a longitudinal section through a sensor element of a proportional probe according to the prior art;

FIG. 3 shows a cross section through a sensor element of a mixed potential sensor according to the prior art;

FIG. 4 shows a longitudinal section through a sensor element according to a first exemplary embodiment of the solid electrolyte gas sensor according to the invention;

FIG. 5 shows a longitudinal section through a sensor element according to a second exemplary embodiment of the solid electrolyte gas sensor according to the invention;

FIG. 6 shows a plan view of a trimmable resistor meander for calibrating the oxygen transport in a solid electrolyte gas sensor according to the invention;

FIG. 7 shows a longitudinal section through a sensor element according to a third exemplary embodiment of the solid electrolyte gas sensor according to the invention; and

FIG. 8 shows typical measurement results when using a solid electrolyte gas sensor according to the invention for a propane gas burner.

### DETAILED DESCRIPTION

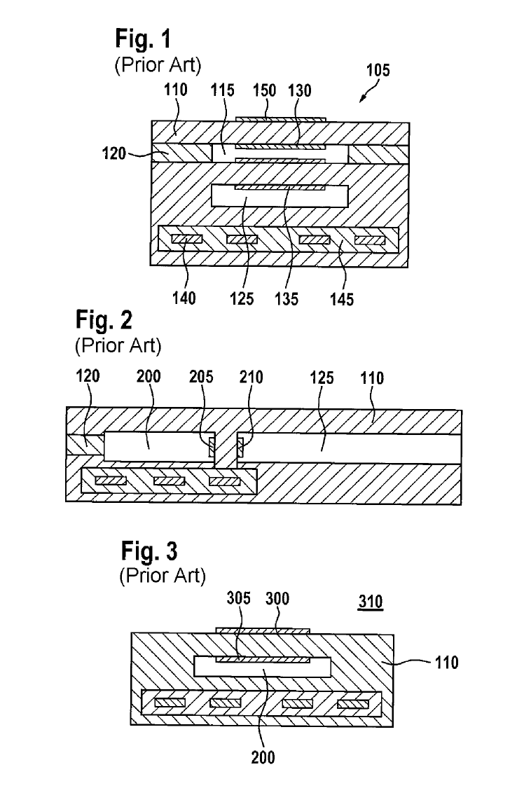

FIG. 1 schematically shows a sensor element 105 of a wideband lambda probe according to the prior art in lateral sectional view. The probe shown therein consists of an yttrium-doped zirconium dioxide body 110 forming an ionically conducting solid electrolyte, inside which body is arranged a cavity (pumping chamber or pumping cell) 115 which is connected via a diffusion barrier 120 to the exhaust gas to be sensed. The sensor element furthermore contains an air reference channel 125 connected to the ambient air. In the exhaust gas, in the cavity 115 and in the air reference channel 125, a cermet electrode 130, 135 is respectively arranged, these being connected via separate leads to electrical connection contacts (pads, not shown here). A heater 140 with associated heater insulation 145 is additionally arranged in the lower region of the sensor element 105, by means of which the working temperature of the sensor element 105 can be adjusted.

In the case of an oxygen-rich exhaust gas, oxygen is continuously removed electrochemically from the pumping chamber 115 by means of the electrode pair IPE 130 and APE 150, specifically until the electrode pair IPE 130 and RE 135 is at a voltage of for example 400 mV. The potential existing on the electrode APE 150 is then positive, relative to the potential of the electrode IPE 130. The oxygen diffusion current in this case continues as an electrically measurable pumping current at the electrodes IPE 130 and APE 150 and is used as a measurement variable for the oxygen partial pressure in the exhaust gas.

In the case of an exhaust gas with an oxygen deficit, on the other hand, the pumping direction is reversed. The potential of APE 150 is then more negative than that of IPE 130. In order to switch over the APE potential, a regulator is used whose input variable forms the voltage between RE 135 and IPE 130.

FIG. 2 shows a longitudinal section through a sensor element of a proportional probe according to the prior art. Similarly as in the case of the wideband probe, oxygen is removed from a diffusion-restricted pumping chamber 200 in the case of proportional probes. The oxygen diffusion current then continues as an electrically measurable pumping current between an inner sensor electrode 205 and an (inner) reference electrode 210 and is used as a measurement variable for the oxygen partial pressure in the exhaust gas. Yet since there is no information about the rich or lean state of the exhaust gas owing to the lack of information (control variable) from the unloaded Nernst cell, there is in this case also no possibility of reversing the pumping direction as a function of the exhaust gas composition into the pumping chamber, i.e. pumping oxygen electrochemically in or out so as to produce a wideband probe.

As will be described in more detail below and as has already been indicated here, with the inventive arrangement of an autonomous pumping chamber in such a proportional probe, and the associated closed pumping chamber, wideband measurement operation is nevertheless possible with oxygen-deficient and oxygen-rich exhaust gas, even though this type of sensor has only two contacted electrodes. By means of the invention, the number of contract lines can therefore be reduced from three to two (plus the required heating contacts) with this type of probe.

FIG. 3 in turn shows a mixed potential sensor known from the prior art in a view similar to the previous figures. Mixed potential sensors are constructed from an electrochemical cell, with a first electrode 300 being arranged in the exhaust gas path. A second platinum electrode 305 is separated by a solid electrolyte 110 from the exhaust gas space 310 arranged above the first electrode 300 in this case, and is in communication with the ambient air by means of an air reference channel (not shown here; corresponding to the reference “125” in FIG. 2).

In a mixed potential sensor, there are the following electrical potential conditions. An electrochemical equilibrium is set up in the vicinity of the electrode surface of the catalytically active platinum electrode in the exhaust gas. The difference between the electrode potentials is given according to the Nernst equation (Eq. 1).

$${U}_{N} ( {p}_{{O}_{2}}^{Exhaust gas} ) = \frac{k \cdot T}{4 \cdot F} ln ( \frac{{p}_{{O}_{2}}^{Reference}}{{p}_{{O}_{2}}^{Exhaust gas}} ) \qquad ( 1 )$$

If the outer sensor electrode SE is modified, for example by applying an additional electrode material or replacing the electrode material, this electrode no longer behaves in a way corresponding to an equilibrium electrode; rather, it follows the properties of a mixed potential electrode whose electrode potential is determined by the kinetics of the electrode reaction. The sensor signal U_{M} is given by the difference between the two electrode potentials:

U_{M}(pₒ_{₂}^{Exhaust gas})=φ_{SE}(pₒ_{₂}^{Exhaust gas})−φ_{RE}(pₒ_{₂}^{Reference}) (2)

The reference electrode (RE) is at the reference potential of the measurement circuit (GND). The reference potential is consequently set independently of the gas atmosphere.

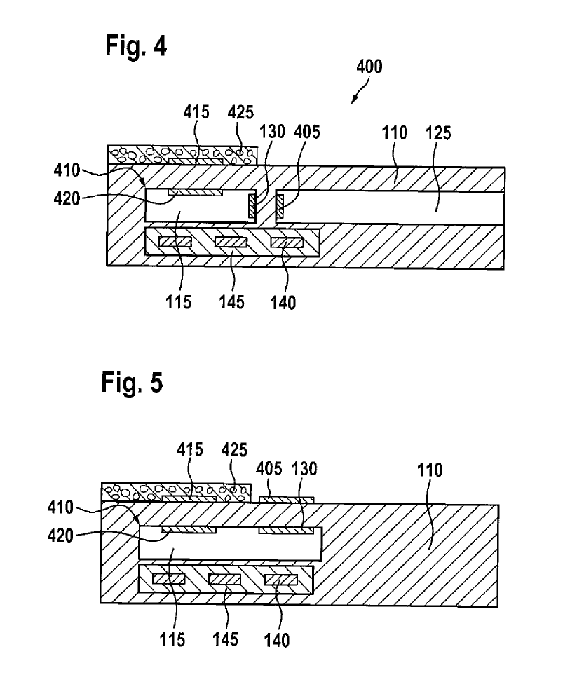

Two exemplary embodiments of sensor elements of a solid electrolyte gas sensor according to the invention will be described below with reference to FIGS. 4 and 5.

The sensor element 400 according to the invention is constructed in a similar way to the types of probes described above and comprises a pumping chamber 115, a heater 140, an inner pumping electrode PE2 130 arranged in the pumping chamber, and a further pumping electrode PE1 405. The pumping electrode PE1 405 is arranged either in the exhaust gas (FIG. 5) or in the air reference channel 125 (FIG. 4).

In order to achieve sufficient ionic conductivity of the solid electrolyte 110, the sensor element 400 is adjusted to the required operating temperature by the heater 140.

In contrast to standard sensors, however, the pumping chamber 115 is sealed gas-tightly 410 from the exhaust gas. In addition, there is a further electrode AUPE1 415 and AUPE2 420 respectively in the exhaust gas and in the pumping chamber 115, although according to the embodiment they are not contacted outward i.e. from the sensor element to an evaluation circuit, and for this reason they are referred to below in all cases as “autonomous” pumping electrodes.

The gas inflow, or the gas inflow restriction, in this sensor element 400 is produced by said autonomous pumping cell 415, 110, 420, 115, 410 instead of the diffusion barrier known in the prior art. A Nernst voltage (two Nernst or oxygen electrodes, for example Pt-Pt) is formed according to the oxygen concentration gradient between the exhaust gas and the gas-tight pumping chamber 115, 410, and in the case of a loaded or short-circuited pumping cell 415, 110, 420 said Nernst voltage causes transport of oxygen into the pumping chamber 115, 410 or out of the pumping chamber 115, 410 (migration current) without application of an external electrical voltage.

As an alternative, a mixed potential electrode (FIG. 3) may also be used as an outer autonomous pumping electrode (AUPE1), so that depending on the electrode material the sensor is suitable for detecting oxygen (mixed potential formation inter alia for HC and CO with oxygen) and for detecting further gas species (selective mixed potential formation, for example NH₃, NOₓ, CO, etc.).

The following may be envisaged as possible electrode materials for the sensor element according to the invention:

Nernst electrodes (for example Pt, Pd, Ir, Ta) or combinations of these materials, or combinations with further constituents, in particular ones comprising ceramic components such as so-called “cermets”.

Mixed potential electrodes (for example Au, Ag, Cu, Zn) or combinations of these and/or the above materials, or combinations with further constituents, in particular ones comprising ceramic components such as so-called “cermets”.

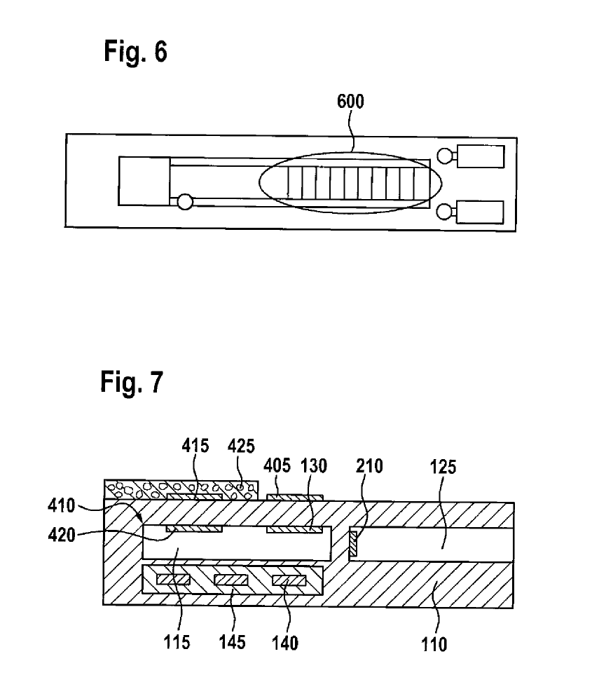

The oxygen transport may be adjusted by loading the autonomous pumping cell 415, 110, 420 by means of a resistor (from freewheel to short circuit). This may for example be done by using a trimmable resistor meander (for example laser balancing). In the event of an unexpected product variance, this may also be used in the production process as a simple and economical possibility for sensor calibration (FIG. 6). Under normal production conditions, however, balancing is usually not necessary.

The resulting voltage in the case of two oxygen electrodes is determined by the oxygen partial pressure set up (concentration and/or change in the absolute pressure). When using a gas-tight pumping chamber 115, 410 (only defined gas inflow via the autonomous pumping chamber and by the active pumping process), electrode voltages of more than |U|>0.9 V may also occur, compared with the gas inflow restriction by means of a porous diffusion barrier (according to the prior art) owing to the lack of convective exchange and consequently reduced or elevated pressure and/or because of a very small oxygen partial pressure in the pumping chamber. Thus, a Nernst voltage of more than 900 mV with respect to an air reference may be achieved even without the presence of an actual rich gas, resulting from a reduced pressure in the pumping chamber 115, 410.

Particular properties and advantages of the autonomous pumping chamber 115, 410 according to the invention are therefore:
Oxygen transport is possible without application of an external voltage or current (otherwise 2 further electrical contacts would be required for this).
Full separation of the measurement electrodes from the exhaust gas (no poisoning phenomena, soot buildup, etc. possible on the measurement electrodes).
Characteristic curve of the gas inflow (by oxygen ion conduction) is dependent on the difference in the oxygen partial pressures (concentration and/or change in the absolute pressure) between AUPE1 and AUPE2.
When using two Nernst electrodes, the superposition of an LSF characteristic curve U_{N}=f(λ) and a component due to a change in the absolute pressure is obtained for the autonomous pumping cell. The current resulting from this in the event of a load or short circuit leads to oxygen transport through the pumping chamber.
When using at least one mixed potential electrode, the superposition of a mixed potential characteristic curve U_{N}=f(λ) (flattened LSF characteristic curve) and a component due to a change in the partial pressure is obtained for the autonomous pumping cell. The current resulting from this in the event of a load or short circuit leads to oxygen transport through the pumping chamber. This variant may be used both as an oxygen sensor and for the detection of further gas species.
The electrical connection of the two electrodes belonging to the autonomous pumping chamber (electrode 1, AUPE1|solid electrolyte|electrode 2, AUPE2), besides the variant described in FIG. 6 which preferably comprises an electrical resistor in the form of a meander 600 represented therein, may also be produced directly by using a mixed-conducting solid electrolyte (ionic and electronic conductivity). In the second said variant mentioned, the system is therefore short-circuited or loaded by means of itself. The degree of loading can be set by the level of electrical conductivity (material properties of the electrolyte).

According to an alternative embodiment, the described autonomous pumping cell 415, 110, 420 may also be used as a replacement for the diffusion barrier of a standard wideband probe (LSU) (see also FIG. 7 described below).

The underlying measurement principle of the described exemplary embodiments will be presented below with reference to the example of using the first exemplary embodiment (FIG. 4) for the quantitative detection of oxygen. For the detection of further gas species, a similar measurement principle may be employed while taking account of the modified mixed potential electrodes.

The gas inflow restriction is set with the aid of the properties of the autonomous pumping cell 415, 110, 420 (loaded to short circuit) either directly in the sensor element or, in the case of contacts fed out of the autonomous pumping cell, in the evaluation circuit. A constant voltage is applied between the pumping electrodes PE1 130 and PE2 405, similarly as in the case of the described proportional probes (so-called LSP operation). Different states of the closed pumping chamber 115, 410 (various oxygen concentrations to reduced pressure) may be set according to the applied pumping voltage.

According to the gas composition of the exhaust gas and inside the closed pumping chamber 115, 410, an oxygen ion flow into the pumping chamber 115, 410 is formed which, owing to the continuity equation, corresponds to the oxygen ion flow through the pumping chamber 115, 410. The associated electrical pumping current of the pumping chamber 115, 410 tapped off by means of PE1 130 and PE2 405, which is directly proportional to the oxygen ion flow, can therefore be used as a measurement variable for the oxygen partial pressure in the exhaust gas.

In the event of an intentional reduced pressure in the chamber, a positive pumping current can be generated even with rich exhaust gas (see the example measurement below). In other cases, a unique characteristic curve with positive or negative sign is obtained.

FIG. 7 represents a sensor element according to the invention according to a third exemplary embodiment (variant 3) of the invention, wherein the measurement principles already described above according to FIGS. 2 and 5 are combined together. Variant 3 is therefore based on the standard LSU regulation principle used in the wideband probes described above. The associated sensor characteristic curves are changed according to the properties set for the autonomous pumping chamber according to the invention (i.e. electrode material and load), as described above.

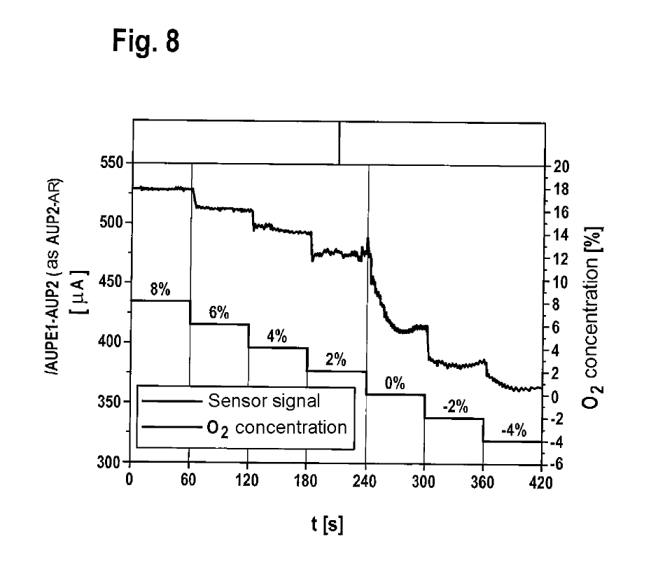

FIG. 8 shows a measurement signal resulting from a step change in the oxygen excess (lean range) or the oxygen demand (rich range) with the respective measurement parameters with reference to the example of a sensor element according to FIG. 4 (variant 1). In this application example, the closed pumping chamber was arranged in the exhaust gas stream of a propane gas burner.

Although the electrode inside the pumping chamber has its potential less than 1 V below the potential of the air reference electrode (U_{AUPE2-PE2}<−1 V), owing to the reduced chamber pressure intentionally set in this mode and/or because of a very low oxygen partial pressure, a positive pumping current is nevertheless achieved which can be assigned to a unique characteristic curve. In principle, other combinations of a loading resistor and pumping voltage are also possible. These likewise result in unique characteristic curves, possibly with positive or negative signs.

The sensor variants described here can be used for detecting the oxygen partial pressure (wideband) inter alia in motor vehicle tailpipes. In principle, however, depending on the sensor variant respectively used, and in particular the electrode material used and the temperature, quantitative determination of various other gas constituents may also be envisaged, for example:
combustible gases (hydrocarbons, hydrogen, ammonia, etc.)
gases containing oxygen (nitrogen oxides, carbon monoxide, etc.).

1. A sensor element for a solid electrolyte gas sensor, which comprises a pumping chamber, a heater and a first pumping electrode arranged in the pumping chamber, as well as an at least second pumping electrode, characterized in that an autonomous pumping cell is arranged as a gas inflow restriction.

2. The sensor element as claimed in claim 1, characterized in that the autonomous pumping cell comprises an outer autonomous pumping electrode and an inner autonomous pumping electrode, which are not contacted from the outside.

3. The sensor element as claimed in claim 2, characterized in that the at least two pumping electrodes of the autonomous pumping cell are operated while being ohmically loaded or electrically short-circuited.

4. The sensor element as claimed in claim 3, characterized in that the pumping properties of the autonomous pumping cell are established by means of the ohmic load respectively set.

5. The sensor element as claimed in claim 2, characterized in that the inner autonomous pumping electrode is arranged either in an exhaust gas or in an air reference channel of the sensor element.

6. The sensor element as claimed in claim 2, characterized in that adaptation of the sensor element to the detection of different gas species is carried out by modification of the outer autonomous pumping electrode.

7. The sensor element as claimed in claim 1, characterized in that the autonomous pumping cell comprises an outer autonomous pumping electrode and an inner autonomous pumping electrode, which are contacted from the outside by a controller by means of which the at least two autonomous pumping electrodes can be modified from the outside.

8. The sensor element as claimed in claim 7, characterized in that a diffusion behavior or a gas inflow restriction, similarly as in the case of a diffusion barrier, is simulated by means of the at least two autonomous pumping electrodes which can be modified from the outside.

9. The sensor element as claimed in claim 8, characterized in that the electrical resistance of the at least two autonomous pumping electrodes can be varied by means of the controller.

10. The sensor element as claimed in claim 1, characterized in that the pumping chamber is sealed gas-tightly from a gas flow to be detected.

11. The sensor element as claimed in claim 1, characterized in that a Nernst voltage, which causes transport of oxygen into the pumping chamber or out of the pumping chamber, is formed according to the oxygen concentration gradient between a gas flow to be detected and the autonomous pumping cell.

12. The sensor element as claimed in claim 2, characterized in that the outer autonomous pumping electrode used is a mixed potential electrode so that, depending on the electrode material, the sensor element is suitable for the detection of further gas species.

13. The sensor element as claimed in claim 8, characterized in that Pt, Pd, Ir, Ta or combinations of these materials or with further constituents are used as electrode materials in the case of Nernst electrodes, or Au, Ag, Cu, Zn or combinations of these and/or the aforementioned materials are used in the case of mixed potential electrodes.

14. The sensor element as claimed in claim 1, characterized in that oxygen transport is balanced by ohmic loading of the autonomous pumping cell by means of an electrical resistor.

15. A solid electrolyte gas sensor for the detection of gases, characterized by a sensor element as claimed in claim 1.

16. A method for operating a sensor element as claimed in claim 1 for the quantitative detection of oxygen, the method comprising:
applying a constant voltage between the at least two pumping electrodes (130, 405); and
using the resulting electrical pumping current as a measurement variable for the oxygen partial pressure in an exhaust gas.

17. The method as claimed in claim 16, characterized in that different states of the autonomous pumping cell (115, 410) are set by means of the constant voltage applied to the pumping electrodes (130, 405) and/or by the interconnection of the autonomous pumping electrodes (415, 420) themselves.

18. The method as claimed in claim 16, characterized in that a reduced pressure is set in the autonomous pumping cell (115, 410), so that a positive pumping current is still generated in a rich exhaust gas with a relatively low lambda value.

19. The sensor element of claim 13, wherein the further constituents comprise ceramic components.

20. The sensor element of claim 19, wherein the ceramic components comprise cermets.

21. The sensor element of claim 14, wherein the electrical resistor comprises a trimmable resistor meander.
